(19) United States
(12) Patent Application Publication
(10) Pub. No.: US 2026/0257235 A1
(43) Pub. Date: Sep. 3, 2026

(54) APPARATUS, SYSTEM AND METHOD FOR COORDINATED FLUID DISPERSAL

(71) Applicant: JOHN BASIL, MARLBOROUGH, MA (US)

(72) Inventor: JOHN BASIL, MARLBOROUGH, MA (US)

(21) Appl. No.: 19/245,261

(22) Filed: Jun. 21, 2025

Related U.S. Application Data
(60) Provisional application No. 63/685,237, filed on Aug. 20, 2024.
(60) Provisional application No. 63/776,118, filed on Mar. 23, 2025.
(60) Provisional application No. 63/796,585, filed on Apr. 29, 2025.
(60) Provisional application No. 63/797,997, filed on May 1, 2025.
(60) Provisional application No. 63/805,801, filed on May 14, 2025.
(60) Provisional application No. 63/808,001, filed on May 19, 2025.
(60) Provisional application No. 63/809,872, filed on May 21, 2025.
(60) Provisional application No. 63/811,865, filed on May 25, 2025.
(60) Provisional application No. 63/815,903, filed on Jun. 1, 2025.

(51) Int. Cl. B05B 12/00; B05B 13/00; B05B 13/04; B05B 17/04; B05D 1/40

(52) U.S. Cl. CPC B05B 12/004; B05B 13/005; B05B 13/0405; B05B 13/0431; B05B 17/04; B05D 1/40

(57) ABSTRACT

Apparatuses, systems, and methods for proactive prevention of adverse conditions and promotion of desirable conditions, providing dynamic adaptation to changing environmental conditions, scalable deployment in varied geographic contexts, reduced reliance on human monitoring and response, optimization via advanced algorithms and machine learning, and deployment in remote or arid regions without fixed water infrastructure, and comprising one or more fluid dispersal units (FDU) which may be embodied as standalone FDUs with purely mechanical sensors and valves, remotely-activated FDUs with embedded electronics and wireless receivers, mobile FDUs with autonomous guidance and obstacle avoidance, and/or aerial drone network managed by predictive models and real-time inputs, with hybrid fluid sourcing, including underground infrastructure and atmospheric water machines, and utilizing mathematical modeling for FDU placement and fault management.

### CROSS-REFERENCES TO RELATED APPLICATIONS

This application claims the benefit, under 35 U.S.C. § 119(e), of
U.S. Provisional Patent Application No. 63/685,237 filed on Aug. 20, 2024,
U.S. Provisional Patent Application No. 63/685,237 filed on Oct. 22, 2024,
U.S. Provisional Patent Application No. 63/776,118 filed on Mar. 23, 2025,
U.S. Provisional Patent Application No. 63/796,585 filed on Apr. 29, 2025,
U.S. Provisional Patent Application No. 63/797,997 filed on May 1, 2025,
U.S. Provisional Patent Application No. 63/805,801 filed on May 14, 2025,
U.S. Provisional Patent Application No. 63/808,001 filed on May 19, 2025,
U.S. Provisional Patent Application No. 63/809,872 filed on May 21, 2025,
U.S. Provisional Patent Application No. 63/811,865 filed on May 25, 2025, and
U.S. Provisional Patent Application No. 63/815,903 filed on Jun. 1, 2025, each of which is hereby incorporated by reference in its entirety.

### TECHNICAL FIELD

The present invention relates to coordinated particle dispersal and, more specifically, to coordinated particle dispersal inducing desired environmental conditions, including the prevention and suppression of wildfires, as well as the fertilization and protection of vegetation.

### BACKGROUND

Wildfires pose increasing threats to ecosystems, property, and human lives. While the risk of wildfires is elevated by increasing outdoor temperatures, the risk of increasing outdoor temperatures is elevated by emissions and vegetation damage caused by wildfire; a cycle with no apparent natural intervention at risk of producing increasingly adverse conditions.

Where vegetation may contribute to planetary atmospheric repair and lowering outdoor temperatures, which reduces the risk of wildfire, the need for prevention and suppression of wildfires, as well as the fertilization and protection of vegetation, becomes more evident.

Traditional approaches to wildfire prevention and suppression often depend on manual intervention based on static analyses. An alternative approach depending on automated intervention based on proactive analyses could overcome drawbacks in traditional approaches producing more efficient and effective wildfire prevention and suppression.

### SUMMARY

The present invention may be described by a system for coordinated fluid dispersal comprising one or more fluid dispersal units which may be stationary or mobile, grounded or aerial, and may be equipped with self-propulsion via solar-powered motors and navigation via onboard sensors, with relocation based on updated risk models; and may further include transport systems guided by similar predictive models and central coordination for suppression, situational awareness and/or transport.

Mathematical optimization models may determine deployment strategy for minimizing cost and maximizing coverage and effectiveness. Fluid sources may include municipal connections or integrated water-producing systems. Optimization models may inform placement, suppression strategy, and, in case of system failures, network reconfiguration.

### BRIEF DESCRIPTION OF DRAWINGS

FIG. 1.1 is a process flow diagram describing an embodiment of the present invention.

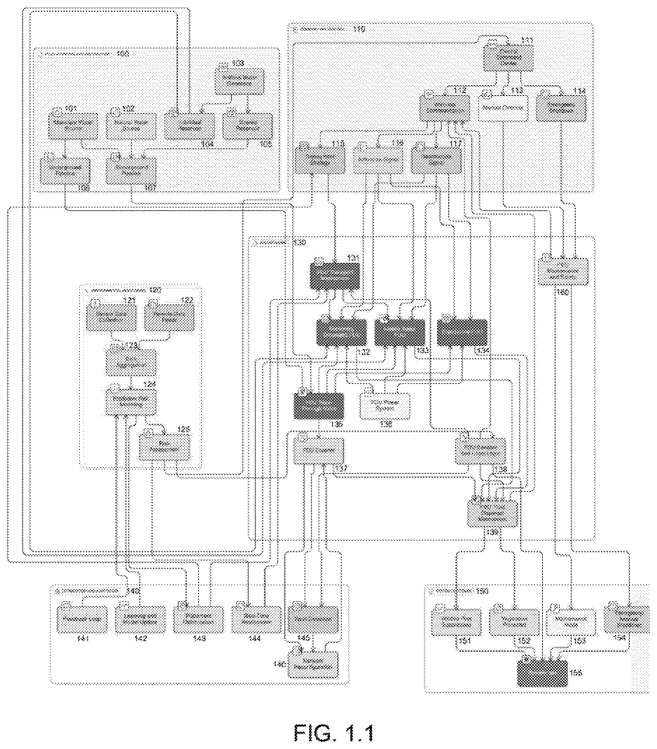

FIG. 1.2 is a process flow diagram describing an embodiment of the present invention.

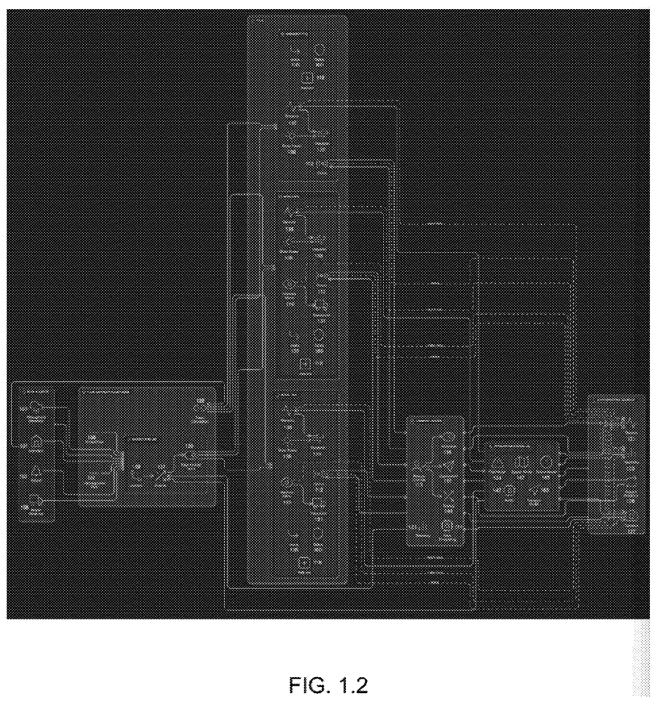

FIG. 2.1 is a technical drawing of an embodiment of a fluid dispersal unit.

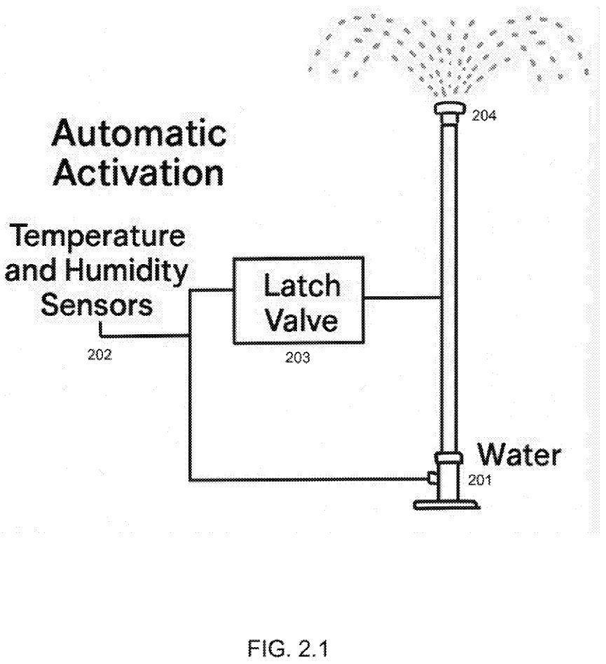

FIG. 2.2 is a technical drawing of an embodiment of a fluid dispersal unit.

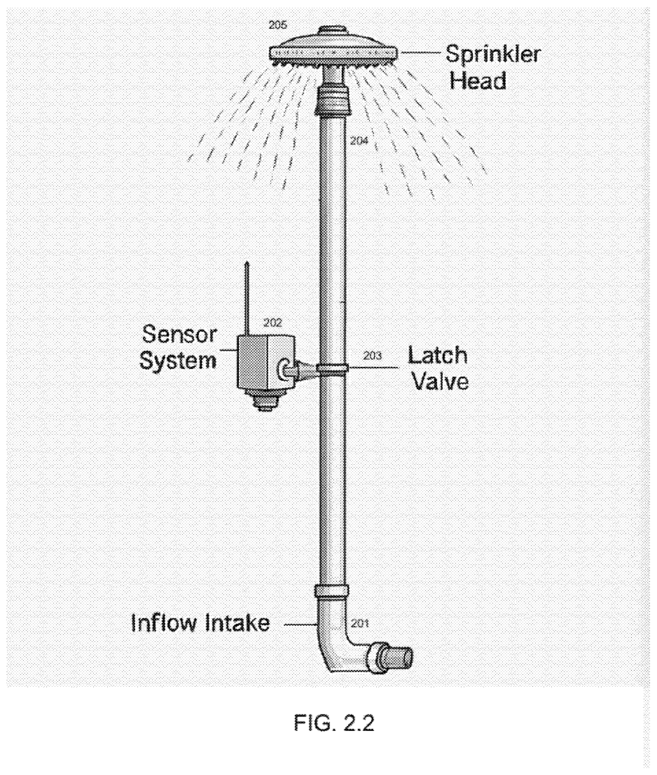

FIG. 2.3 is a technical drawing of an embodiment of a fluid dispersal unit.

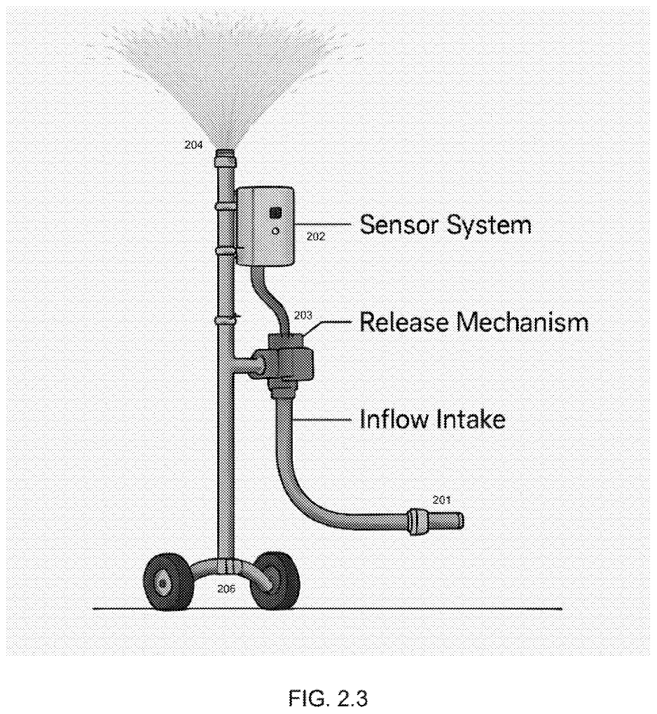

FIG. 2.4 is a photographic view of an embodiment of a fluid dispersal unit.

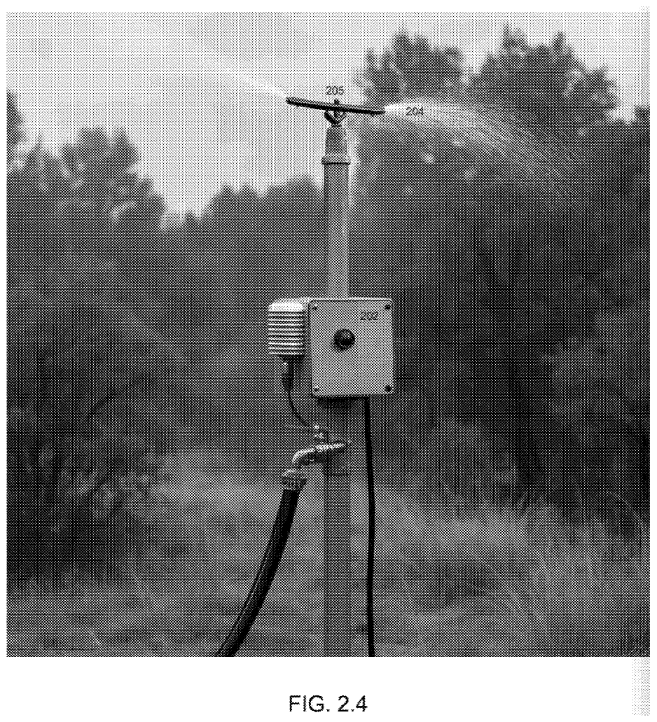

FIG. 2.5 is a photographic view of an embodiment of a fluid dispersal unit.

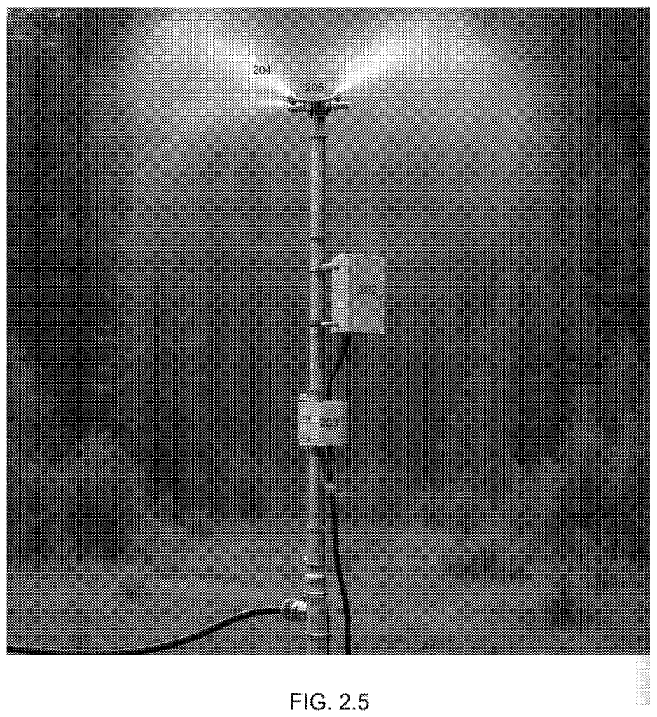

FIG. 2.6 is a photographic view of an embodiment of a fluid dispersal unit.

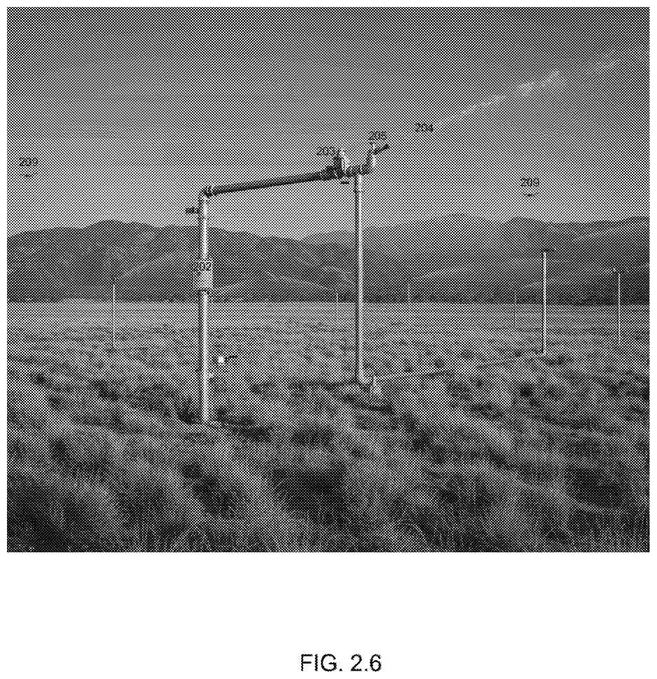

FIG. 2.7 is a photographic view of an embodiment of a fluid dispersal unit.

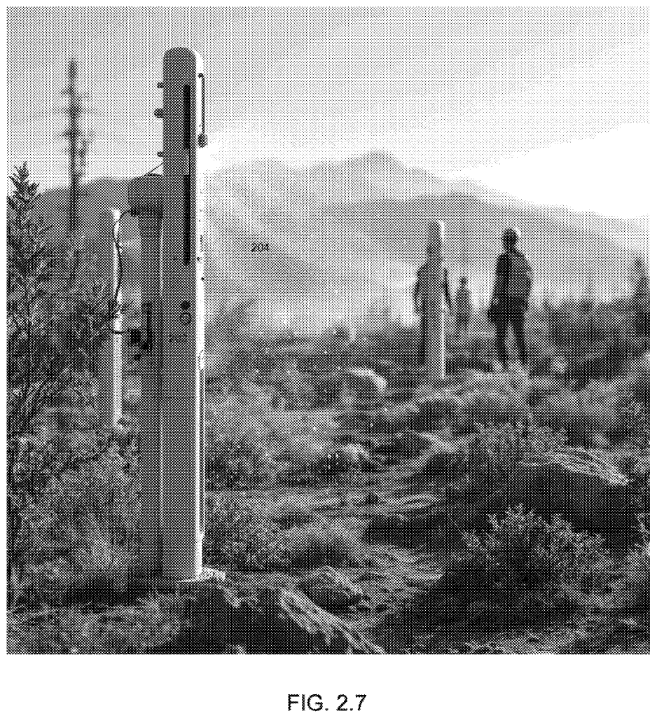

FIG. 2.8 is a photographic view of an embodiment of a fluid dispersal unit.

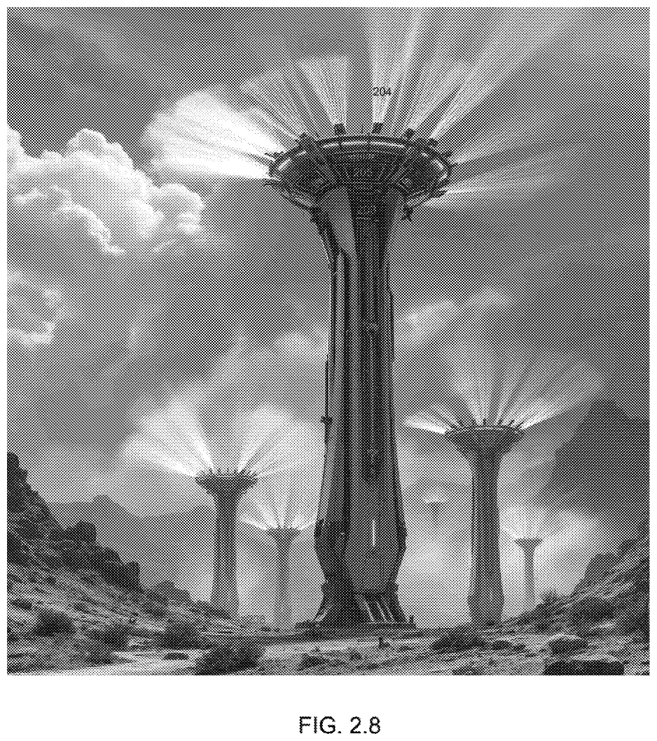

FIG. 2.9 is a photographic view of an embodiment of a fluid dispersal unit.

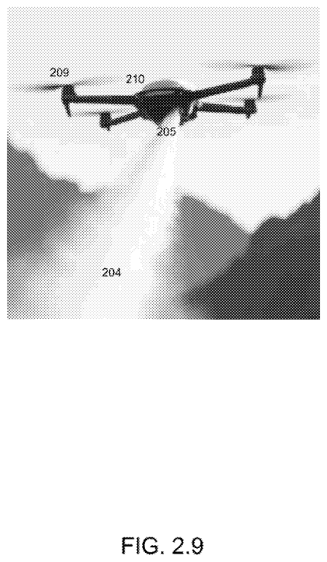

FIG. 2.10 is a photographic view of an embodiment of a fluid dispersal unit.

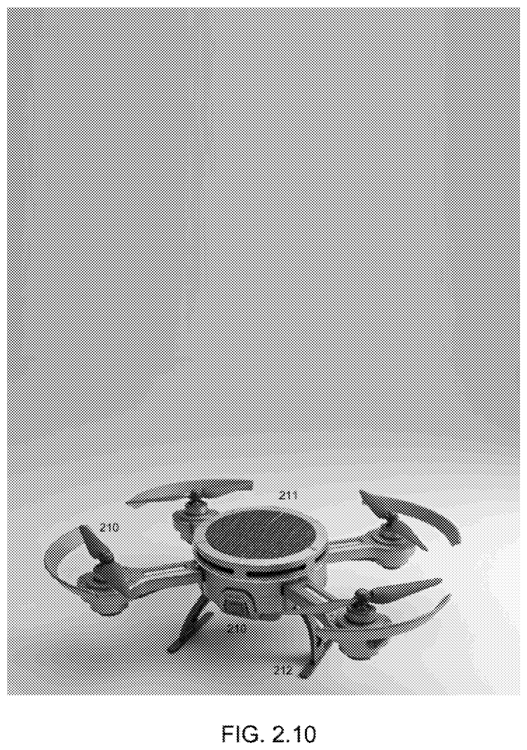

FIG. 2.11 is a photographic view of an embodiment of a fluid dispersal unit.

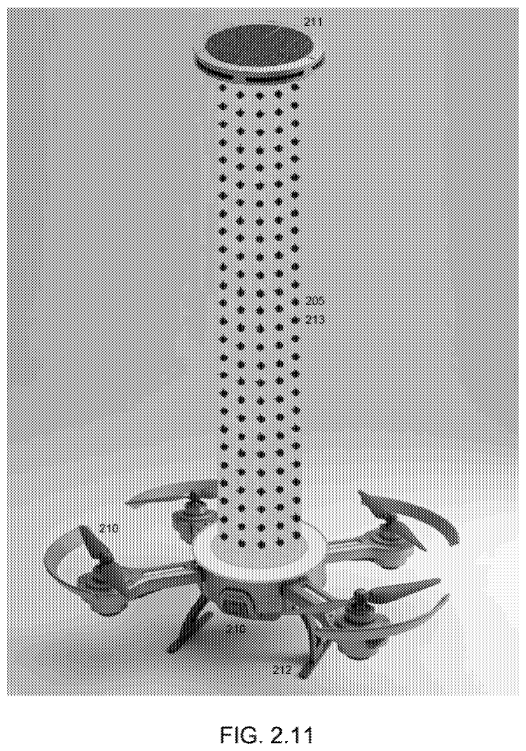

FIG. 2.12 is a photographic view of an embodiment of a fluid dispersal unit.

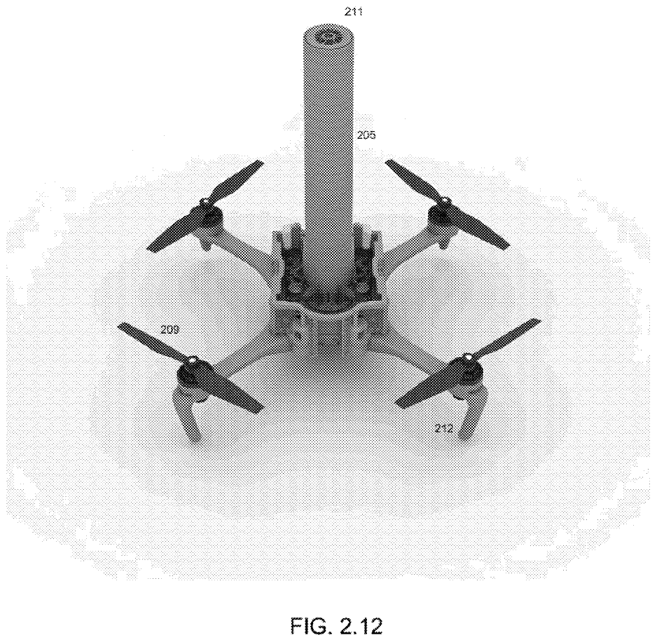

FIG. 2.13 is an isometric view of an embodiment of a fluid dispersal unit.

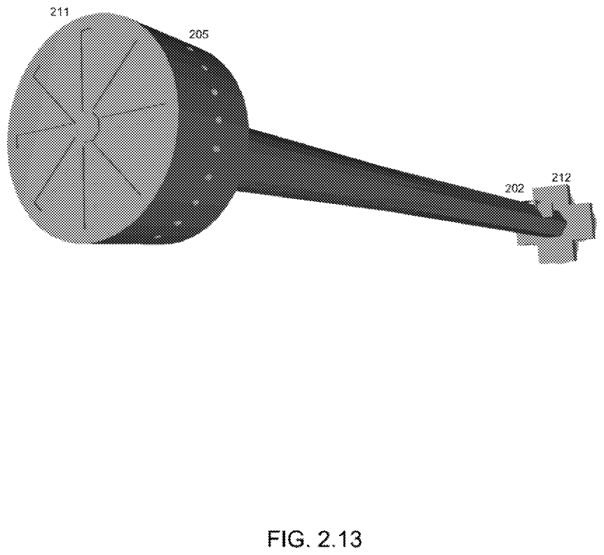

### DETAILED DESCRIPTION

The present invention may be described by a system for coordinated particle dispersal 139, 204 comprising one or more fluid dispersal units (hereafter referred to as, FDU). These FDU may disperse particles such as fluid 139, 204 in order to prevent and/or suppress adverse environmental conditions 151 as well as to promote and/or propagate desired environmental conditions 152.

Environmental conditions may include temperature, wind, humidity, fertilization, flammability, and/or any quality or quantity of an observed environment that can be distinguished using sensory equipment 138, 202 (hereafter referred to as, sensors). Both, adverse environmental conditions and desired environmental conditions, may be described by the increase and/or decrease of certain environmental conditions.

Adverse environmental conditions (hereafter referred to as, adverse conditions) may include decreased ambient humidity, decreased fertilization, increased flammability and/or any environmental condition that could be prevented and/or suppressed 151 by the operation of FDU.

Desired environmental conditions (hereafter referred to as, desirable conditions) may include increased ambient humidity, increased fertilization, decreased flammability, and/or any environmental condition which could be promoted and/or propagated 152 by the operation of FDU.

A desirable condition may be described by the prevention and/or suppression of an adverse condition, and an adverse condition may be described by the lack of promotion and/or propagation of a desirable condition.

Fluid 204 dispersed by the FDU may include water, plant fertilizer, flame suppressant, and/or other liquids that may prevent and/or suppress adverse conditions as well as promote and/or propagate desirable conditions.

The aforementioned acts of prevention and/or suppression of adverse conditions as well as promotion and/or propagation of desirable conditions are, hereafter, referred to, collectively, as, treating. The aforementioned adverse conditions as well as desirable conditions are, hereafter, referred to, collectively, as, informing conditions.

Each FDU may comprise in its operation a mechanism for:
Fluid supply 101, 102, 103,
Fluid intake 135, 201,
Activation and deactivation 116, 117, 138, 203,
Placement and relocation 143, 144,
Fluid dispersal 139, 204,
Automated functionality 112, 118, 136, 138, 211,
Transportation 131,
Remote communication and command 110,
Performance-enhancing adjustments 124, 140,
and/or other features conducive to its operation.

Where possible, each mechanism may be embodied as either: a physically-integrated preinstalled mechanism to a new FDU system, or a physically-disparate add-on mechanism to an existing FDU system.

Fluid flowing through the FDU intake 135, 201 may be sourced from:
Municipal infrastructure 101 (e.g., underground water mains),
Natural sources 102 (e.g., nearby lakes, rivers, or groundwater, which may be pumped to the intake 135, 201),
Artificially-generated sources 103 (e.g., atmospheric water generators, condensers, chemical extraction systems),
A combination of approaches (preferring municipal where available),
and/or other sources conducive to fluid accessibility.

Artificially-generated sources 103 include fluid-producing machines capable of producing fluid via condensation, humidity extraction, or chemical reaction. Where access to fluid is desired, the fluid source may be provided from a reservoir 104, 105 storing the fluid generated by the fluid-producing machine 103. Such a fluid-producing machine 103 could be embodied by any one of a number of systems that produces an output of fluid, by any one of a number of mechanisms including collection, condensation, extraction, and/or chemical reaction.

As such, the reservoir 104 from this machine 103 could serve as the fluid source 105 for a network of FDUs interconnected 208 by fluid line, or as the fluid source for a single FDU, with each FDU being connected to the reservoir 104, 105 of one of these machines, potentially eliminating the need for an interconnecting fluid line. Alternatively, these generators 103 may include a built-in reservoir 104 and serve one or more FDUs locally, particularly in off-grid environments, or may collect water into a separate reservoir 105 serving as the fluid source for multiple FDUs.

Sourced fluid of the FDU may be distributed on the basis of:
Individual connections to one or more fluid sources (e.g., single reservoir for multiple FDU 105 or single reservoir for each FDU 104),
Interconnections between FDU via a shared pipeline system 106, 107,
A combination of approaches depending on accessibility (e.g., preferring interconnected fluid distribution 208 where available and remediating to individualized connection),
and/or other connection approaches conducive to fluid accessibility.

Interconnecting FDU via a shared pipeline system 106, 107 enables flow across multiple FDUs, with fluid routed as needed through conduits located either underground 106 or aboveground 107. The material composition of aboveground conduits 107 could be that of durable, flexible materials such as high-density polyethylene (HDPE).

Fluid distribution strategy can be further distinguished by the following two embodiments. In a first embodiment, each FDU is connected independently to a dedicated fluid source such as a municipal 101 underground 106 main, a reservoir 104, 105 or a fluid machine 103. In a second embodiment, FDUs are interconnected 208 via aboveground 107 or fixed buried 106 pipeline network. A single point of connection (e.g., fire hydrant 101, portable fluid tank 104, shared reservoir 105, or mobile fluid generator 103) provides fluid to the network. The fluid 204 flows through the pipeline 106, 107, bypassing closed (inactive) FDUs and supplying active ones. FDUs may contain pass-through valves 135, 201 that permit unidirectional flow even when inactive, ensuring the pressurized fluid can reach more distant units.

For fluid distribution, these FDUs could at the inflow intake 135, 201, either, individually connect to a fluid source (e.g., to existing underground fluid pipes 106), or be mutually-connected, with one water connection to one inflow intake 135, 201 (e.g., using aboveground fluid pipes 107 made of flexible and highly-durable material like high-density polyurethane, where the flow simply passes through the deactivated FDUs with closed latches until reaching destination FDU). The embodiment with aboveground pipes 107 would be more sensible when tapping an above-ground fluid source such as a fire hydrant or a waterline from a house or other building. Either embodiment is also optionally mobile (just disconnect the pipe from the intake 135, 201 and transport 131 the FDUs).

The mechanism for controlling fluid dispersal 139, 204 for each FDU may be implemented by:
A purely mechanical approach (e.g., pressure differential, bimetallic actuation),
An electromechanical approach (e.g., solenoid activated by analog or digital control
circuitry),
A hybrid approach (e.g., combining mechanical sensitivity with electronic overrides),
and/or other approaches conducive to fluid dispersal 139, 204.

This mechanism may be configured to treat its environment by activating 116 and deactivating 117 fluid dispersal, or placing 143 and relocating FDU 144, on the basis of a variety of signals.

In operation, FDU placement 143, relocation 144, activation 116, and deactivation 117 is based on:
Locally-or remotely-detected environmental thresholds (e.g., temperature above X° C., humidity below Y %) 138,
Alerts from centralized control systems or command centers 110,
Statistical and/or computation model risk projections 124, 125,
and/or other indicators of high probability of adverse conditions or low probability of desirable conditions.

In one embodiment, when environmental sensor readings 121 (e.g., thermostat, hygrometer, wind gauge, infrared) surpass thresholds indicative of adverse conditions such as high risk for wildfire (e.g., high temperature and/or low humidity and/or high winds) or drought (dry or sparse observable vegetation), the fluid dispersal mechanism 139, 203 (e.g., as by the opening of a latch valve 203) of the FDU is activated. When environmental sensor readings 121 return to normal levels (i.e. below thresholds indicative of adverse conditions and/or above thresholds indicative of desirable conditions), the fluid dispersal mechanism 139 (e.g., as by the closing of a latch valve) of the FDU is deactivated.

Thresholds indicative of, either, adverse conditions or desirable conditions, may be preset, and/or adjusted either manually 113 and/or automatically. The FDU may feature electronic and mechanical controls for manual and automatic adjustments and presets 207. In the case of electronic adjustment, the threshold may be adjusted remotely, as by a remote control, which may comprise buttons for manual adjustment 113, or which may comprise a wireless receiver 112 for signals from command center, where the thresholds may be automatically determined from an active risk/likelihood assessment 125 for informing conditions considering that the thresholds may change depending on a plurality of extraneous environmental conditions.

In one embodiment, thresholds indicative of adverse conditions or desirable conditions are adjusted as by the turning of a knob, which clockwise-circulates a loaded lever inside of the gauge mechanism that, when crossed by the reading dial indicator, releases a spring-loaded lever (i.e. bit flip), producing a signal to indicate activation (e.g., ‘risk: on’) which feeds into, and trips the release on, the corresponding lever of a lever combination (i.e. bit flip) that acts as a lock on the release mechanism (e.g., a latch valve).

When all gauges are indicated as activated, all levers (i.e. bits) of the lever combination are released, and only then is the release mechanism triggered (i.e., a 3-way AND gate). When a gauge reading returns to normal level and the reading dial indicator counterclockwise-circulates the released lever, the lever spring is loaded, the signal feeding into the lever combination on the release mechanism is cut off, and the corresponding lever on the lever combination is reset (e.g., ‘risk: off’).

Other embodiments could achieve the same functionality, such as by physically representing bits and signals using electromagnetic waves. For example, the same functionality may be achieved on exceeding the gauge threshold, by sending a signal from the gauge to activate one bit on a digital bit combination controlling the fluid dispersal mechanism 139, 203, beginning fluid dispersal 116 when all bits on the bit combination have been activated, and stopping fluid dispersal 117 when at least one bit on the bit combination is deactivated by cutting off the signal from the gauge to activate one bit on the bit combination.

In another embodiment, this functionality is achieved by sending wireless signals from a transmitter connected to the gauge to a receiver connected to the fluid dispersal mechanism 139, 203, where a signal is sent each time the threshold boundary is crossed, where the initial signal activates a bit, and the subsequent signal deactivates the corresponding bit on the bit combination. In yet another embodiment, the rotational direction of the gauge transmits a different signal that, depending on the nature of the transmitted signal which the receiver is configured to decode, either activates or deactivates the corresponding bit on the bit combination.

The system for mitigating high risk/likelihood of informing conditions may comprise a distributed network of FDUs strategically positioned in areas prone to such conditions. Placement may be determined by predictive models 124 that assess likelihood and extent of adverse conditions or desirable conditions under different environmental condition using real-time and historical data 122 related, but not limited, to precipitation, temperature, humidity, vegetation condition, wind speed, and topography, in order to determine the necessary environmental adjustments for achieving desirable conditions or averting adverse conditions, and from this information select the optimal fluid dispersal 139, 204, strategy utilizing all available variables (e.g., dispersal location, timing, intensity, direction, etc).

These methods or models may be based on machine learning algorithms 142, rule-based systems, and/or a hybrid of statistical and computational methods or models. These methods or models may help determine areas prone to adverse environmental conditions and/or a lack of desired environmental conditions as well as the information to relay through signal transmission (e.g., geolocation, activation/deactivation, valve pressure release, nozzle angle, etc.).

To enable automated functionality across diverse environments, the FDUs may be outfitted with:
Solar panels 136, 211,
Control circuitry,
Wireless transceivers 112,
Cameras and machine vision systems 127, 138, 210,
and/or other electronics as demanded by individual design requirements 118.

Solar panels 211 may be mounted externally in order to supply power 136 to electronics and mechanical systems. Control circuitry may interpret sensor input 121, manage activation logic, and respond to remote signals 112. Wireless transceivers 112 could send and receive signals from a centralized command center or neighboring FDUs, enabling coordinated activation. Cameras 127, 138, 210 and machine vision systems 119 could facilitate terrain monitoring 124, obstacle avoidance during movement 143, 163, or confirmation of fire suppression efficacy 145.

Where manual overrides 113 and remote control are also supported, an FDU may be configured to detect when pausing dispersal would be safe and, on a request to pause dispersal, activated by remote control (e.g., pedestrian crossing request button), wait until the time period determined to be safe for pause, then pause dispersal, while possibly transmitting signals supporting the function of an indicator sign (e.g., pedestrian crossing light or countdown). Cameras 127, 138, 210 and/or machine vision systems 119 could detect pedestrians or other sensitive conditions and generate a configured response such as an alert or temporary pause.

The fluid may be dispersed by a nozzles 205 which are either conventional nozzles, or specialized nozzles. Specialized nozzle 205 s may be optimized for a plurality of objectives including wide-area dispersion and elevation-induced flow variability. Nozzles 205 may also include directional control mechanisms to rotate or angle the spray radius based on topographical needs or wind conditions. In some embodiments, pressure regulators are included to adjust for flow rate and terrain elevation.

A single FDU may feature multiple nozzles 205 which may be also be fully embedded into other aspects of the FDU design, such as one or multiple extensible and/or flexible necks with nozzles 205 along the lining of the neck or upon an attached dispersal head residing at one edge of the neck, with the other edge forming, or connecting into the body of, the FDU. Multidirectional dispersal powered by jets or turbines could enable distant horizontal and vertical reach especially for distant risk-prone elements beside, above, and/or below the FDU, such as brushes or old trees.

This intervention could prevent adverse conditions or promote desirable conditions at the source by identifying areas at high-risk for such adverse conditions, then placing FDU in these high risk areas, which can be automatically activated by indicators of environmental conditions (such as local sensory equipment 138 or remote meteorological monitors 122) crossing thresholds indicative of informing conditions, which trips a switch 116 that opens a latch valve 203 releasing fluid 204. This latch valve control 116 may be either purely mechanical or partially electronic.

Where FDU mobilization is desired, each FDU may be equipped with:
Wheels 206,
Helicopter blades 209,
and/or other mechanisms for transport (hereafter referred to as transporters 131).

In a stationary embodiment 132, FDUs lack transporters, and may be designed for permanent installation, such as by connecting directly to an existing underground water main 106.

In a mobile embodiment 133, FDUs may be connected to some transporter such as rotating wheels 206, rollers, castors, motorized treads, hovering platforms, rotating blades 209, and/or wings, with movement guided by embedded GPS receivers, navigation algorithms, and real-time feedback from mounted cameras 127, 138, 210. The transporter may be permanently connected (i.e., built-in) or may be optionally connected (i.e., added-on; removable) to the FDU. In the latter case, adding transporters to a stationary FDU would transform the FDU into a mobile FDU. These FDUs can be remotely repositioned to new locations based on updated risk models 124. Machine learning algorithms may be embedded locally or run on a remote server 142, updating FDU locations dynamically 144 based on environmental data 123 and predictive simulations 124.

In either a stationary or mobile embodiment, FDUs are interconnected 208 by aboveground piping 208 which may be constructed of flexible, high-density polyurethane. In this configuration, fluid can flow sequentially from FDU to FDU, enabling cost-effective deployment in remote or rugged terrain, particularly where tapping a single source such as a fire hydrant is practical. FDU that are not capable of interconnection are considered standalone FDU 134.

Alternatively or in addition, a transportable FDU may collect water by extraction of moisture from air as by a dehumidifier, or generate water internally as by chemical reaction, from different locations. In this embodiment, the FDU may utilize AI 142 and/or meteorological data 123 to travel to geographies or altitudes with conditions suitable for water collection such as geographies or altitudes with greater air moisture where a water-generating machine extracting moisture from air 103 is utilized.

Movement 131 could be directed remotely from a command center, with or without human assistance. In this case, electricity for powering 136 the motor to drive the transporters could be sourced from solar panels 211 affixed the exterior of each FDU. Models 124 predicting adverse conditions (e.g., wildfire) and/or desirable conditions (e.g., fertilization), used to optimize the placement 143 of each FDU, could specify a geographic location where the FDU should move to, and receivers/transmitters 138 physically embedded into each FDU could direct the FDUs to move 144 to that specified location. Cameras 127, 138, 210 affixed to the exterior of each FDU combined with machine vision 119 could help direct the FDUs to that specified location avoiding obstacles in the terrain.

The FDU assembly may be designed using industry-standard fittings and weather-resistant materials to ensure durability under a variety of environmental conditions. The modular design of each unit facilitates transport 131, maintenance 160, and deployment 115 in field conditions. Safety features may include emergency shut-off valves, anti-backflow mechanisms, failsafe deactivation 117 logic in the event of sensor failure or signal loss 145, terrain leveling detection with automated motorized and/or hydraulic adjustment 38, and retractable and/or extensible stabilizing legs 212 which automatically deploy after completing transport 131 to desired position and retract before beginning transport.

A command center may issue wireless signals to activate or deactivate individual FDUs or entire FDU networks. A centralized command center may issues signals for:
FDU activation 116 and deactivation 117,
FDU deployment 115 and transport 131,
Re-routing decisions 144,
Real-time telemetry 123,
Sensor data 121 processing,
and/or other actions where data-based decision making and/or remote control is desired.

Each FDU may be equipped with a sensor 138 to monitor fluid availability and report back 112 to the command center, allowing dynamic redistribution or emergency alert in the event of a local supply issue. The system may utilize predictive modeling 124 to inform both the initial placement of mitigation FDUs and the dynamic activation of components in real time. These models process environmental data streams and historical datasets 123 to evaluate risk with respect to adverse conditions such as wildfire ignition, growth, and spread, and/or likelihood with respect to desired conditions 125.

In a coordinated control scenario, predictive models 124 can deploy optimal sets of FDUs to activate in advance of a forecasted spike in risk. These deployments can be dynamically updated based on changing conditions including new sensor data 121, aerial surveillance, and/or weather conditions 122.

Statistical models identify likely points of ignition or spread, and optimize:
FDU transport paths 163,
Energy/fluid efficiency,
Fluid dispersal location and duration,
Fluid dispersal direction, intensity, and nebulization (e.g., as by a spray settings),
Return trajectories,
and/or other aspects of FDU functionality which benefit from data-based decisions.

Transport guidance systems may incorporate onboard AI, GPS navigation, and communication relays to FDUs or satellites, and may also detect heat sources or smoke to dynamically adapt operations. A complementary optimization model 143 could ensure that transport routes do not overlap or cause inefficiencies as well as that fluid is dispersed 139, 204 only where it will effectively suppress adverse conditions or promote desirable conditions.

The placement of FDUs is determined using a spatial optimization model 143. Data inputs may include:
Infrared imaging,
Smoke detection,
Wind vector predictions,
Meteorological variables (e.g., temperature, humidity, wind speed),
Topographic data (e.g., slope, vegetation index),
Historical wildfire data (e.g., ignition points, burn zones),
Land-use patterns and human activity indicators,
and/or other data inputs depending on availability.

Models predicting risk 124 for adverse conditions such as wildfire or absence of desirable conditions such as fertilization to spread to a particular location could be used to optimize the flight path and payload dispersal 139, 204 of aerially-transported FDU equipped with an extinguishing liquid or foam connected to a command center via satellite or cell unit. Such FDU could also combine sensory capabilities 138 such as infrared imaging and air monitoring in order to further optimize the flight path and payload dispersal 139, 204.

The modeling framework may label land regions (modeled as a graph of nodes) into:
Ignition-prone zones (where fire is likely to start),
Propagation-prone zones (where fire may spread),
Separator zones (where FDUs should be placed to prevent spread),
and/or other classifications as would be helpful to distinguish.

This control center could also be used to activate the dispersing FDU of the aforementioned intervention. The FDU could be activated from a control center by embedding in the design of a single FDU or a network of FDU an antenna that receives signals (e.g,. as from a cell FDU or satellite), these signals indicating that an FDU or set of FDU should be activated. The signals could be connected to a circuit which reads in different types of signals and, depending on the nature of the signal, determines the appropriate response (i.e., whether to open or close one or more specific FDU, or all FDU).

Such optimization problems may be formulated as graph-theoretic models, where:
Nodes (e.g., representing FDUs or pipeline junctions),
Edges (e.g., representing connections between them),
A “repair group” and/or “functional group”,
An objective function (e.g., that minimizes the number of cross-connections between these groups),
and/or other model parameters as would be useful for distinguishing descriptive subsets as well as for satisfying the inputs of the objective function.

These model may be implemented using integer programming, constraint solvers, or reduced to Quadratic Unconstrained Binary Optimization (QUBO) format for execution on a quantum annealer, allowing rapid recalibration of flow routing in dynamic conditions.

In one embodiment, with respect to models predicting risk 124, either for potential wildfire to start in a particular location, or for active wildfire to spread to a particular location, groups of tree networks are distinguished, with one group being labeled as that where wildfire is predicted to begin or is active, and another group being labeled as that where wildfire could spread to based on where it is predicted to or has already started. A third separator group could assign a node to each FDU, with an objective function defined as that where the number of separators, or FDUs, is minimized to maintain at least one separator between any node of the first tree network and any node of the second tree network. Thus, no cross edges would exist between tree networks.

For M nodes and N tree networks, multiple binary variables are defined as xi, j, with each corresponding to nodes of a tree network from a set of tree networks and indicating either that a given node is in the given network or not in the given network, as well as a separator network, defined as x_{i,N+1}, for i=1, 2, . . . , M, and j=1, 2, . . . , N. Thus, the goal is to minimize the sum of all xi, N+1, while maintaining that no cross-edges exist between any two given tree networks x_{i,j}, and that any given node is not assigned to more than one network.

This model can be expanded to relocate FDU based on the presence of other informing conditions in order to treat the affected environment.

To ensure resilience in case of partial system failure (e.g., an FDU or connection becomes non-functional), an optimization model can be employed to:
Detect the affected segment 145,
Minimize disruption to active FDUs,
Identify alternate routing paths 146 via available diverters 137,
and/or other goals depending on the model parameters and objective.

Diverters 137 may be embedded within the pipeline system 106, 107 to reroute 144 fluid flow around faulty or disabled FDUs. These diverters 137 are controlled by signal-receiving actuators powered by onboard solar energy or battery storage 136. A central command center may activate specific diverters 137 in real-time, based on feedback from sensor data 122 and network connectivity status 126.

With respect to the possibility to a link in the FDU network disrupting the flow of fluid between FDUs, diverters 137 inside of the fluid pipes could be controlled from a remote command center 111 by receiver 112 connected to the FDU network driven by motors powered 136 by electrical signals fed from aforementioned solar panels 211. In order to optimize how to divert fluid to minimize the impact of the faulty link, all connected FDUs exhibiting codependency as by, for example, waterline distribution, could be represented as a network.

This FDU network could also be separated into groups as by, for example, a repair group and a functional group. Furthermore, the minimal subset of the FDU network that is in the repair state (i.e., cannot be restored by being diverted away from a disabled connection) can be represented as one FDU network and the presently functional side of the network being represented as a second FDU network. In order to prevent the repair side of the network from disrupting fluid flow to the functional side of the network, while minimizing the number of connections diverting the second group away from the first subset, an objective function could be defined to minimize the number of cross-edges between the two subsets.

For M nodes of an FDU network, a binary variable is defined as xi, indicating either that the node is in the repair subset or not in the repair subset, for i=1, 2, . . . , M. Thus, the goal is to minimize the sum of all magnitudes between all xi (or square differences, with, for each element under summation, 1 representing a cross-edge), while maintaining that any given node is not assigned to more than one subset of the tree network.

This model could be further expanded to other scenarios involving a repair group and functional group, with nodes representing some component of a node of the FDU network (and not necessarily the FDU themselves) as by, for example, a fluid connection or junction, with the functionality representing any functionality of the FDU network (and not necessarily fluid flow) as by, for example, electricity 136 (distributed from a source such as solar panels 211, batteries and/or electrical wires) or network connectivity 112 (distributed from a source such as a wireless receiver/transmitter and/or internet cables).

Either of the above-referenced objective functions could hypothetically be reduced to quadratic unconstrained binary optimization (QUBO) problems and solved using a quantum annealer in order to determine the global minimum, for nodes in the first case and for cross-edges in the second case.

The design of the FDU system may be customized in order to optimize:
Cost efficiency (most basic features)
Modularity or design flexibility (e.g., add-on features),
Performance (e.g., built-in features or all-in-one),
and/or other parameters based on user constraints and/or preferences.

For a more modular design enabling scalability and customizability for unique constraints of varying ecosystems, each FDU feature could be incorporated as an add-on. For example, a base purely-mechanical grounded FDU could feature multiple inputs for controlling fluid dispersal 139, 204 (e.g., as by a latch valve 203), so that fluid dispersal 139, 204 could be controlled by signals from an add-on receiver for signals from a remote command center 111 in addition to an augmentable set of local atmospheric sensors 138, 202. The FDU could also feature fittings which connect (e.g., latch on) to add-on aerial transporters (e.g., detatchable blades 209 or wings) with receivers for signals from a remote command center 111 for transporting the FDU to different locations.

The end pipe connecting to the dispersal 139, 204 head may be replaced with an extensible pipe driven by a motor which may be driven by signals received from a remote command center 111. This pipe may be extended and retracted by the screwing and unscrewing of a threaded pipe, or the pushing and pulling of a piston pipe. Alternatively, the extensible pipe may be driven by the release of water into a flexible membrane or a rigid set of rings connected by flexible material 213 that becomes turgid and extends fully when filled with fluid while excreting fluid from nozzles 205 along the length of the pipe, and becomes flaccid and collapses when fluid flow ceases. The add-on aerial FDU may themselves feature fluid collection, depositing and dispersal 139, 204 capabilities the same as grounded FDUs for expanding the network of available resources for preventing and suppressing wildfire 151. These aerial FDU could also stand-alone, where grounded FDUs serve as ad-hoc additions to a mixed network of aerial and grounded FDU.

In another embodiment, FDU are deployed 115 from command centers or remote stations to preemptively suppress emerging fire hotspots 151. The drone may have the ability to open a hatch securing the reservoir 104 as well as position the reservoir 104 for collection from the targeted water source. The drone may also be equipped with the FDU dispersal mechanism 139, 204 including nozzles 205 for spraying the fluid 204 over locations, such as those identified as wildfire threats.

In yet another embodiment, the FDU collects water from a water source, searches for areas susceptible to wildfire and, upon detection of such an area, disperses the water over the area. This FDU may also be equipped with an extensible (e.g., telescoping) vertical pipe along the length of which are built-in nozzles 205 on all sides. At the top of the pipe are the helicopter blades 209 and rotor, with the end cap atop the helicopter blade rotor, the top of which is lined with a solar panel 136, with the center of the solar panel 136 featuring a perforation for the placement of a vertically-directed nozzle 205.

Upon detecting an area susceptible to fire, the FDU lands, levels itself, extends stabilizing legs 212, extends the vertical pipe permitting the space needed to drop the helicopter blades 209 so that they are vertically aligned with the pipe before dropping the rotor connecting the blades 209 down into the housing of the FDU, before the vertical pipe is extended to the optimal dispersal height with all nozzles 205 exposed, at which point the FDU is able to disperse water over the area.

Upon lowering wildfire risk to acceptable levels, the FDU might stop dispersing and either wait until local risk is elevated again or until receiving signal from the command center to change location, or return to the air scanning for higher risk areas. In either case, when returning to the air, the FDU automatically contracts its stabilizing legs 212, raises its rotor and extends its helicopter blades 209 horizontally, before depressing the vertical pipe into the housing of the FDU.

The nature and extent of dispersal 139, 204 may be either pre-programmed or AI-driven. Data collection 123 could also entail examination of conditions over areas where dispersal 139, 204 previously occurred as well as precise actions taken in the course of dispersal 139, 204, which could be fed back for manual or AI evaluation for augmenting the patterns of dispersal 139, 204 and improving the success rate of deterrence efforts.

An example of a fluid-generating machine 103 is an atmospheric water generator such as a dehumidifier which may, optionally: enclose the motor with sound dampeners such as sound-insulated panels to provide for a more tolerable auditory experience, as well as, equip humidity sensors 138, 202 capable of detecting 121 the direction of greater humidity and within a certain threshold (which may also be calibrated by the manufacture and/or user) autonomously move the unit to a location of greater humidity in order to expedite moisture extraction.

Such a fluid-generating machine 103, as either a standalone unit separate from, for fully integrated with, the dispersal 139, 204 mechanism and related physical components of the FDU, may be transported 131 along the ground 132 (e.g., as by wheels 206 or casters at the bottom of the unit) and/or through the air 133 (e.g., as by rotating helicopter blades 209 at the top of the unit). In either case, the unit may move itself to the nearest drain to empty its reservoir 104, 105 upon reaching a certain capacity (which may also be calibrated by the manufacturer and/or user). The humidity sensors 138, 202 could be embodied by any one of a number of mechanisms for determining 121 the direction of greater humidity including as a set of sensors located on either side of the unit (e.g., in the order of 4n with greater n enabling greater sensitivity) and as a single sensor unit comprised of numerous individual microsensors tilted in various directions.

An example of a fully-integrated (i.e., built-in) atmospheric water generator 103 is an FDU equipped with various sensors 138, 202, for detecting conditions conducive to wildfire from the ground, as well as a receiver 112, for connectivity to a command center transmitting, to the drone, data 123 such as weather or geographical information or AI-driven actions, as well a transmitter 112 for connectivity to a command center receiving, from the drone, sensor data 138 which could augment AI-driven actions or refine stored weather or geographical information. This drone may also be equipped with a reservoir 104 which is filled with water collected from the nearest water source, the location of which is based either on nearby weather patterns and/or geographical markers for autonomous collection or on manually-specified beacons.

As an alternative to built-in fluid sourcing, water endpipes could be extended upward from the ground at strategic locations enabling the FDU to be transported between endpipe locations, where at the desired endpipe location, the FDU latches its intake valve 135, 201 into the endpipe. In addition, these endpipes may be fitted with custom end caps. These end caps may be designed in such a way as to seal the connection between the endpipe and FDU intake valve 135, 201 as well as to seal access to an untapped endpipe (i.e., an endpipe that is not connected to an FDU) so as to prevent tampering.

In one embodiment, the endpipe features a closed gasket with a brim that the FDU latches its intake valve 135, 201 into and opens by some mechanism. One possible such mechanism is by a twist of the FDU intake valve 135, 201 which when latched into the gasket brim twists the gasket brim which opens the gasket. Another such possible mechanism is by the depression or insertion of a latch key by which the FDU intake valve 135, 201 is latched into the gasket.

The present invention may be modified to replace fluid in any of the above-references with any stream of particles of matter regardless of the state or the scale of the matter. For example, the nozzles 205 of the present invention may disperse a cooling gas in order to lower temperatures or photons oscillating at various frequencies in order to achieve varying results, such as ultraviolet frequency for facilitating vegetation photosynthesis (i.e., a desirable condition), or frequencies visible to human eye-sight for dangerous, low visibility (e.g., foggy) areas (i.e., an adverse condition).

What is claimed is:

1. An apparatus for coordinated fluid dispersal (i.e. a fluid dispersal unit), comprising:
1. a fluid intake port configured to receive fluid from at least one of:
1. a municipal water line,
2. a natural reservoir, or
3. a fluid-generating machine;
2. a fluid dispersal mechanism comprising one or more nozzles configured to direct fluid into an environment;
3. a dispersal control unit operatively coupled to the fluid dispersal mechanism and configured to activate and deactivate fluid dispersal based on one or more input signals;
4. a sensor suite comprising at least one of:
1. a temperature sensor,
2. humidity sensor,
3. wind sensor,
4. optical sensor, or
5. machine vision system, configured to monitor environmental conditions;
5. a wireless communication module configured to send and receive control signals from a remote command center;
6. a mobility subsystem comprising at least one of:
1. wheels,
2. rotors, or
3. aerial propulsion means;
7. a controller operatively connected to the sensor suite, communication module, and mobility subsystem, the controller executing machine-readable instructions to:
1. evaluate sensor data against a set of environmental condition thresholds;
2. activate the fluid dispersal mechanism when one or more adverse environmental conditions are detected;
3. deactivate the fluid dispersal mechanism when the adverse environmental conditions subside or upon receipt of a remote deactivation signal;
4. update location based on predictive risk models;
5. and navigate to a new location for fluid dispersal based on updated environmental data or command center instructions.

2. A system for coordinated environmental fluid dispersal, comprising:
1. a plurality of fluid dispersal units (FDUs) according to claim 1;
2. a network of fluid distribution lines connecting two or more FDUs, wherein each FDU includes a pass-through valve permitting unidirectional flow when inactive;
3. at least one fluid source selected from:
1. municipal connection,
2. natural reservoir, or
3. fluid-generating machine;
4. at least one command center configured to:
receive environmental data from one or more FDUs;
5. determine risk of adverse environmental conditions using predictive modeling;
6. generate deployment, activation, or reallocation signals based on environmental risk assessments;
7. transmit the signals to one or more FDUs via the wireless communication module;
wherein each FDU is configured to receive the signals and adjust operational behavior accordingly.

3. A method for coordinated fluid dispersal for environmental management, the method comprising:
1. deploying a plurality of fluid dispersal units (FDUs) to target geographic zones;
2. collecting environmental condition data via sensors embedded in the FDUs;
3. analyzing the data at a command center using predictive risk models to assess the probability and severity of adverse environmental conditions;
4. transmitting, from the command center to the FDUs, activation, relocation, or deactivation commands based on the analysis;
5. dispersing fluid at one or more FDUs when conditions meet or exceed preconfigured thresholds;
6. dynamically updating threshold values and FDU locations in response to evolving conditions or system feedback;
wherein the fluid is selected from:
1. water,
2. fertilizer,
3. flame suppressant, or
4. other environmentally beneficial substances.

4. The apparatus of claim 1, wherein the sensor suite comprises a telescoping vertical mast integrated with sensors and nozzles.

5. The apparatus of claim 1, wherein the controller comprises a local fallback routine executable during loss of communication with the command center, maintaining autonomous threshold-based operation.

6. The apparatus of claim 1, wherein local AI evaluates fire or vegetation stress using onboard infrared and visible spectrum analysis.

7. The apparatus of claim 1, wherein each FDU includes modular power systems with swappable battery packs and solar charging interfaces.

8. The system of claim 2, wherein the command center is configured to implement machine learning algorithms that update predictive models based on historical and real-time data.

9. The system of claim 2, wherein the command center includes a simulation environment for validating deployment scenarios prior to issuing real-world commands.

10. The system of claim 2, wherein FDUs are grouped into autonomous zones managed by edge controllers, each capable of operating independently from the central command center.

11. The method of claim 3, wherein FDU relocation is guided by a graph-theoretic optimization algorithm minimizing the number of units required to separate predicted ignition and propagation zones.

12. The method of claim 3, wherein the system reconfigures itself using a Quadratic Unconstrained Binary Optimization (QUBO) framework in response to system faults.

13. The method of claim 3, wherein threshold-based activation of FDUs comprises an AND-gate logic across multiple environmental inputs before initiation of fluid dispersal.

14. The method of claim 3, wherein the system pauses fluid dispersal upon detecting a human presence in proximity, as determined by machine vision analysis.

15. The method of claim 3, wherein the fluid dispersal pattern is determined in real-time based on wind direction and speed detected by onboard anemometers.

16. The method of claim 3, wherein dispersed fluid includes plant-nourishing additives, selected based on vegetation data collected by FDUs.

17. The method of claim 3, further comprising dynamically adjusting FDU nozzle pressure to compensate for elevation changes across the target terrain.

18. The method of claim 3, wherein a visual indicator system alerts surrounding humans to imminent dispersal activity.

19. The method of claim 3, further comprising disabling fluid dispersal when wind velocity exceeds a defined limit that could compromise dispersal accuracy.

20. The method of claim 3, further comprising:
1. determining fluid type and dispersal parameters using a lookup table correlating vegetation type, soil condition, and environmental threat;
2. adjusting delivery composition accordingly.
